(19) United States
(12) Patent Application Publication
(10) Pub. No.: US 2022/0053077 A1
(43) Pub. Date: Feb. 17, 2022

(54) METHOD FOR DETECTING THE COMPLETION OF A TELEPHONE CALL INITIATED FROM A WEB BROWSER OF A MOBILE COMMUNICATION DEVICE

(71) Applicant: GNI MEDIA, MARSEILLE (FR)

(72) Inventor: Nicolas CHEVALLIER, SAUSSET-LES-PINS (FR)

(21) Appl. No.: 17/425,743

(22) PCT Filed: Mar. 2, 2020
(86) PCT No.: PCT/FR2020/000050

§ 371 Date: Jul. 26, 2021

(30) Foreign Application Priority Data
Mar. 1, 2019 (FR) FR1902142

(51) Int. Cl. H04M 1/2749; H04M 1/72433; H04M 1/253

(52) U.S. Cl. CPC H04M 1/2749; H04M 1/2535; H04M 1/72433

(57) ABSTRACT

The invention relates to a method for detecting the success of a telephone call initiated from a web browser of a mobile communication device, comprising an initial step (20) of detecting a click event on display data of a predetermined web page displayed via the web browser, said display data relating to a telephone number, and a step (28) of establishing a telephone communication between said mobile communication device and a terminal corresponding to said telephone number. The method further comprises the following steps—initializing a time counter when a click event is detected (20); detecting (30) a predetermined event;—stopping said time counter when said predetermined event is detected (30);—if the duration recorded by said time counter is within a predetermined time interval, determining (36) that the telephone call was successful.

### TECHNICAL FIELD

The present invention relates to a method, implemented on a mobile communication device, for detecting the success of a telephone call initiated from a web browser of the device. Such a mobile communication device is a smartphone-type cell phone, for example, or even a digital tablet equipped with a SIM card (“Subscriber Identity Module”), without this being limiting in the context of the present invention.

The invention also relates to a computer program product suitable for implementing such a method.

### PRIOR ART

In the field of mobile communication devices equipped with a telephone call function, there is a need to detect the success of a call initiated from the device. To do this, application programming interfaces are known, also called APIs (“Application Programming Interface”), which are capable of implementing such detection methods. Some of these APIs, which operate in conjunction with an operating system installed on the mobile communication device, are also capable of providing information which indicates the duration of the telephone call made. Such information can then be transmitted via wireless network transmission either to an application internal to the device or external thereto, for use in various applications.

However, such known solutions, based on the execution of APIs, result in a significant consumption of computing resources, both in terms of processor processing resources and memory resources. Indeed, some of these APIs require the implementation of an active listening function for events, which consumes a lot of processor and memory resources. Other APIs, for the implementation of the method for detecting the success of a call, are based on the installation of broadcast receivers for listening to intents of the operating system. Such broadcast receivers are permanently active, even outside of telephone calls initiated from the device, because they also listen to received calls, for example. This again leads to significant consumption of processor and memory resources.

In addition, another disadvantage associated with these API solutions lies in the fact that such APIs know the telephone numbers of the caller and the called party. This entails a significant risk for the confidentiality and protection of the user's personal data. Even though some of these APIs require special permissions to initiate a phone call and/or to know if the call was successful, the confidentiality of personal data relating to the caller number can still be compromised by a malicious person.

Finally, some of these APIs do not make it possible to detect the success of a telephone call initiated directly from a web browser of the mobile communication device.

Methods implemented on mobile communication devices are also known which make it possible to directly establish a telephone communication between the device and an external terminal, following the initiation of the corresponding call from a web browser of the device. Specifically, the call is initiated following an activation by the user, in a web page of their browser, of display data relating to a phone number corresponding to the terminal. Such methods include an initial step of connecting, via the web browser, to a predetermined web page comprising display data relating to the telephone number; a step of detecting, implemented by the processing means, a click event on the display data; and a step of establishing a telephone communication between the mobile communication device and the terminal corresponding to the telephone number.

### SUMMARY OF THE INVENTION

The aim of the invention is therefore to provide a method, implemented on a mobile communication device, which makes it possible to detect the success of a telephone call initiated from a web browser of the device, while reducing the consumption of necessary computing resources and protecting the confidentiality of the user's personal data.

Another aim of the invention is to provide such a method which also makes it possible to obtain an estimate of the duration of the telephone call when it has been successful.

To this end, the invention relates to a method, implemented on a mobile communication device, for detecting the success of a telephone call initiated from a web browser of the device, further comprising memory means, processing means connected to the memory means and provided with a time counter, and communication means connected to the processing means and comprising means for establishing a telephone communication, the method comprising an initial step of detecting, implemented by the processing means, a click event on display data of a predetermined web page displayed via the web browser, said display data relating to a telephone number, and a step of establishing a telephone communication between said mobile communication device and a terminal corresponding to said telephone number, wherein the method further comprises the following steps implemented by the processing means:
initializing said time counter when the click event is detected;
detecting a predetermined event which is pre-stored in the memory means;
stopping said time counter when said predetermined event is detected;
if the duration recorded by said time counter is within a predetermined time interval, determining that the telephone call was successful.

By virtue of the various steps implemented in the method according to the invention, it is possible to indirectly detect the success of a telephone call initiated from the web browser of the device. Indeed, when a predetermined event is detected by the processing means, the program product stored in the device deduces that the user is no longer in telephone communication, then calculates an estimate of the duration of the call and, if this duration is within a predetermined time interval, deduces that the call was successful. Such a predetermined event is, for example, a user interaction event or foregrounding of the process related to the browser. This indirect detection of the success of the telephone call is thus carried out by means of the web browser of the mobile communication device itself, more precisely by means of a browser engine, for example a JavaScript engine, as well by detecting at least one predetermined event. The method according to the invention thus does not use any API, unlike the detection methods of the prior art, which allows a substantial reduction in the consumption of processor and memory resources in the device. The method according to the invention also makes it possible to secure the user's personal data, with in particular a guarantee of preserving the confidentiality of the user's telephone number, since the method operates in a completely anonymous and secure manner and does not require the intervention of any API or any communication of telephone numbers to a third-party application.

Particular embodiments of the detection method are defined according to the invention.

According to a particular technical feature of the invention, the device further comprises an operating system, and the method further comprises, after the step of initializing the time counter, a step which is implemented by the operating system and consists in foregrounding the process related to reestablishing a telephone communication.

According to a particular technical feature of the invention, the device further comprises an operating system, and the method further comprises, after the step of initializing the time counter, a step which is implemented by the operating system and consists in backgrounding the process related to the web browser.

According to a particular technical feature of the invention, the method further comprises, after the step of initializing the time counter, a step which is implemented by the operating system and consists in inhibiting any triggering of an event within the web browser.

According to a particular technical feature of the invention, said predetermined event is either foregrounding of the process related to the web browser by the operating system, or a user interaction event.

According to a particular technical feature of the invention, said user interaction event belongs to a predetermined list of events, said events being events programmed in JavaScript language.

According to a particular technical feature of the invention, the method further comprises, after the step of determining that the telephone call was successful, a step which is implemented by the processing means and consists in storing said duration as the duration of the call in the memory means. This makes it possible to obtain an estimate of the duration of the telephone call when it has been successful.

According to a particular technical feature of the invention, the method further comprises, after the step of determining that the telephone call was successful, a step which is implemented by the processing means and consists in causing the web browser to execute a cache file for displaying a pop-up window, in particular a pop-up window comprising a satisfaction questionnaire. This makes it possible, for example, to display a satisfaction questionnaire on the mobile communication device regarding the content of the telephone conversation.

According to a particular technical feature of the invention, the method further comprises, simultaneously with the initial step of detecting a click event, a step in which the processing means initiate the playback of an empty sound, which empty sound is pre-stored in the memory means, and the method comprises, simultaneously with the step of establishing a telephone communication, a step in which the processing means pause the playback of the empty sound, and, in the step of detecting a predetermined event, said predetermined event is the resumption by the processing means of the playback of the empty sound.

To this end, the invention also relates to a computer program product comprising program instructions which are stored in memory means of a mobile communication device and which, when executed by processing means of the device, are suitable for implementing the method according to the invention as described above for detecting the success of a telephone call initiated from a web browser of the device.

### BRIEF DESCRIPTION OF THE FIGURES

The aims, advantages and features of the method according to the invention will become clearer in the following description on the basis of at least one non-limiting embodiment illustrated by the drawings, in which:

FIG. 1 schematically shows a mobile communication device suitable for implementing the detection method according to the invention; and

FIG. 2 is a flowchart showing the steps of a method for detecting the success of a telephone call according to the invention.

### DETAILED DESCRIPTION OF THE INVENTION

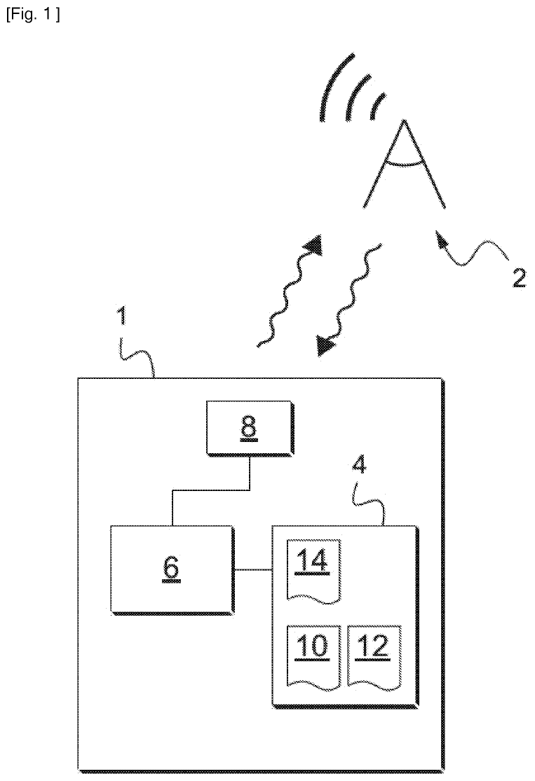

FIG. 1 shows a mobile communication device 1. The mobile communication device 1 is configured to transmit and receive data over at least one data communication network 2. The mobile communication device 1 is further configured to allow telephone communications to be established over such a network 2. The mobile communication device 1 is a smartphone-type cell phone, for example, or even a digital tablet equipped with a SIM card (“Subscriber Identity Module”), without this list being exhaustive.

The data communication network 2 is provided with a private or extended communication infrastructure allowing connection or access to communication equipment such as servers and/or databases and/or communication devices. Typically, the communication infrastructure forms a wireless network, or a wired network, or even a network comprising a wireless portion and a wired portion. In a particular embodiment, the data communication network 2 is designed as a network conforming to the GSM (“Global System for Mobile Communication”), GPRS (“General Packet Radio Service”) or UMTS (“Universal Mobile Telecommunications Systems”) standard, or as a network conforming to the IP protocol, for example an LTE (“Long Term Evolution”) Advanced network.

The mobile communication device 1 comprises memory means 4, processing means 6 connected to the memory means 4, communication means 8 connected to the processing means 6, and a web browser 10 stored in the memory means 4. The mobile communication device 1 also comprises an operating system 12 stored in the memory means 4.

In addition to the web browser 10 and the operating system 12, a computer program 14 is also stored in the memory means 4. The memory means 4 consist for example of a re-programmable non-volatile memory, such as a flash memory.

The processing means 6 are provided with a time counter, for example in the form of a hardware clock or a software function. The processing means 6 consist of one or more processors, for example.

The communication means 8 comprise means for establishing a telephone communication over the network 2. The communication means 8 are formed by a communication interface suitable for transmitting and receiving data over the data communication network 2.

The web browser 10 is typically provided with an engine, for example a JavaScript engine.

Typically, the operating system 12, when executed by the processing means 6, provides a set of functionalities to the mobile communication device 1 which allow said device to operate.

The computer program product 14 can be downloaded from a data communication network 2, for example. The computer program 14 comprises program instructions suitable for implementing a method for detecting the success of a telephone call initiated from the web browser 10 of the device 1, as described below. The program instructions can be executable instructions encoded in JavaScript language, for example.

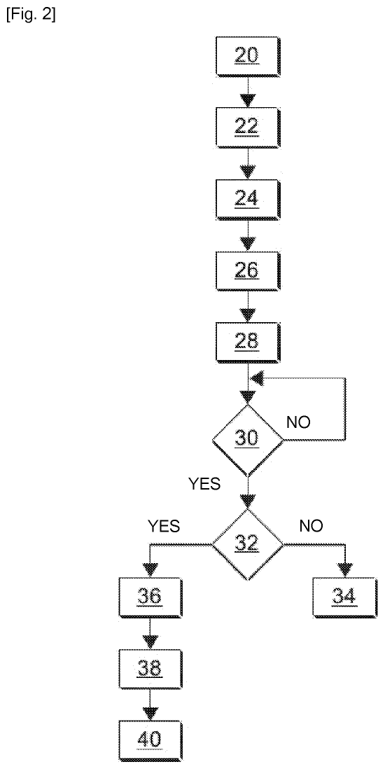

The method for detecting the success of a telephone call initiated from the web browser 10 of the device 1, implemented by the device shown in FIG. 1, will now be described with reference to FIG. 2.

It is assumed that initially a user of the mobile communication device 1 connects via the web browser 10 to a predetermined web page comprising display data relating to a telephone number. It is further assumed that the user of the device 1 decides to initiate a telephone call corresponding to this telephone number directly from their web browser 10. For this purpose, the user activates the display data relating to the phone number via an input interface of their device 1, such as a touchscreen, and such activation can take the form of a manual click on this data displayed on the touchscreen, for example.

In an initial step 20, the processing means 6 detect a click event on the display data relating to the phone number. “Click event” means any event which makes it possible to activate interactive display data, such as a call button, an Internet link, or a JavaScript object with an attached click event handler. This detection of a click event translates, for example, into the detection by the processing means 6 of the execution of a function programmed in JavaScript language in the engine of the web browser 10. Simultaneously with this detection, the processing means 6 execute the computer program 14 with a view to initializing the time counter. According to a particular variant, simultaneously with this detection step 20, the processing means 6 initiate the playback of an empty sound, which empty sound is pre-stored in the memory means 4.

Preferably, in a subsequent step 22, the operating system 12 of the device 1 foregrounds the process related to the establishment of the telephone communication between the device 1 and a terminal corresponding to the telephone number.

Preferably, in a simultaneous or subsequent step 24, the operating system 12 of the device 1 backgrounds the process related to the web browser 10.

Preferably, in a simultaneous or subsequent step 26, the operating system 12 of the device 1 inhibits any triggering of an event within the web browser 10.

It should be noted that the order of steps 22 to 26 described above can be modified at will without departing from the detection method which is the object of the present invention.

In a subsequent step 28, the operating system 12 of the device 1 switches to a telephony management application stored in the memory means 4, and then initiates a telephone communication from the device 1 to a terminal corresponding to the telephone number. In the particular variant in which the processing means 6 have initiated the playback of an empty sound, the processing means 6 pause the playback of the empty sound simultaneously with this step 28.

In a subsequent step 30, the computer program 14 determines whether a predetermined event, which is pre-stored in the memory means 4, has occurred. This step 30 corresponds to dormant listening for the occurrence of the predetermined event. Such a predetermined event is, for example, foregrounding of the process related to the web browser 10 by the operating system 12. Alternatively, the predetermined event is a user interaction event. Such a user interaction event belongs to a predetermined list of events programmed in JavaScript language, for example. Such a list includes for example the following JavaScript interaction events, without this being exhaustive: focus; blur; touchstart; scroll; resize; click; visibilitychange; pagehide; pageshow. These JavaScript interaction events correspond for example to a user touching the touchscreen of the device 1, or resizing a web page or a pop-up window. Alternatively again, the predetermined event is an event corresponding to a resumption by the processing means 6 of the playback of the empty sound. Such an event is an event programmed in JavaScript language, for example. Simultaneously with this detection of a predetermined event, the computer program 14 stops the time counter.

When the computer program 14 has determined that a predetermined event has occurred, it determines in a subsequent step 32 whether the duration recorded by the time counter is within a predetermined time interval. Such a time interval is determined by prior research and corresponds to a time range in which there is a high probability that a telephone call may have been successful and given rise to a telephone conversation.

If the duration recorded by the time counter is not within the predetermined time interval, the computer program 14 estimates in a subsequent step 34 that the telephone call was not successful.

Conversely, if the duration recorded by the time counter is within the predetermined time interval, the computer program 14 determines in a subsequent step 36 that the telephone call was successful.

Preferably, in a subsequent step 38, the computer program 14 stores the duration recorded by the time counter as the duration of the telephone call in the memory means 4 of the device 1.

Preferably, in a subsequent step 40, the computer program 14 causes the web browser 10 to execute a cache file for displaying a pop-up window. Such a pop-up window comprises a satisfaction questionnaire intended for the user of the mobile communication device 1, for example.

It is thus conceivable that such a detection method according to the invention allows the indirect detection of the success of a telephone call initiated from a web browser 10 of the device 1 by involving only the browser 10, and in particular the JavaScript engine of the browser 10, while at the same time reducing the consumption of necessary computer resources and protecting the confidentiality of the user's personal data. Indeed, the consumption by the memory means 4 and the processing means 6 is zero throughout the duration of the telephone communication, unlike the prior art solutions for detecting the success of a telephone call, and in particular solutions based on the execution of APIs.

What is claimed is:

1. Method, implemented on a mobile communication device (1), for detecting the success of a telephone call initiated from a web browser (10) of the device (1), the device (1) further comprising memory means (4), processing means (6) connected to the memory means (4) and provided with a time counter, and communication means (8) connected to the processing means (6) and comprising means for establishing a telephone communication, the method comprising an initial step (20) of detecting, implemented by the processing means (6), a click event on display data of a predetermined web page displayed via the web browser (10), said display data relating to a telephone number, and a step (28) of establishing a telephone communication between said mobile communication device (1) and a terminal corresponding to said telephone number, characterized in that the method further comprises the following steps implemented by the processing means (6):
initializing said time counter when the click event is detected (20);
detecting (30) a predetermined event which is pre-stored in the memory means (4);
stopping said time counter when said predetermined event is detected (30);
if the duration recorded by said time counter is within a predetermined time interval, determining (36) that the telephone call was successful.

2. Method according to claim 1, characterized in that the device (1) further comprises an operating system (12), and in that the method further comprises, after the step of initializing the time counter, a step (22) which is implemented by the operating system (12) and consists in foregrounding the process related to reestablishing a telephone communication.

3. Method according to claim 1, characterized in that the device (1) further comprises an operating system (12), and in that the method further comprises, after the step of initializing the time counter, a step (24) which is implemented by the operating system (12) and consists in backgrounding the process related to the web browser (10).

4. Method according to claim 1, characterized in that the method further comprises, after the step of initializing the time counter, a step (26) which is implemented by the operating system (12) and consists in inhibiting any triggering of an event within the web browser (10).

5. Method according to claim 3, characterized in that said predetermined event is either foregrounding of the process related to the web browser (10) by the operating system (12), or a user interaction event.

6. Method according to claim 5, characterized in that said user interaction event belongs to a predetermined list of events, said events being events programmed in JavaScript language.

7. Method according to claim 1, characterized in that the method further comprises, after the step (36) of determining that the telephone call was successful, a step (38) which is implemented by the processing means (6) and consists in storing said duration as the duration of the call in the memory means (4).

8. Method according to claim 1, characterized in that the method further comprises, after the step (36) of determining that the telephone call was successful, a step (40) which is implemented by the processing means (6) and consists in causing the web browser (10) to execute a cache file for displaying a pop-up window, in particular a pop-up window comprising a satisfaction questionnaire.

9. Method according to claim 1, characterized in that the method further comprises, simultaneously with the initial step (20) of detecting a click event, a step in which the processing means (6) initiate the playback of an empty sound, which empty sound is pre-stored in the memory means (4), in that the method comprises, simultaneously with the step (28) of establishing a telephone call, a step in which the processing means (6) pause the playback of the empty sound, and in that, in the step (30) of detecting a predetermined event, said predetermined event is the resumption by the processing means (6) of the playback of the empty sound.

10. Computer program product (14) comprising program instructions stored in memory means (4) of a mobile communication device (1) and which, when executed by processing means (6) of the device (1), are suitable for implementing the method according to claim 1 for detecting the success of a telephone call initiated from a web browser (10) of the device (1).
